(19) United States
(12) Patent Application Publication
(10) Pub. No.: US 2015/0110112 A1
(43) Pub. Date: Apr. 23, 2015

(54) NETWORK SYSTEM CAPABLE OF ENHANCING CONNECTION PERFORMANCE

(71) Applicant: POWER-ALL NETWORKS LIMITED, Shatin (HK)

(72) Inventors: KAI ZHOU, Wuhan (CN); HAI-TAO LI, Wuhan (CN); MAO-HUA HE, Wuhan (CN)

(21) Appl. No.: 14/511,958

(22) Filed: Oct. 10, 2014

(30) Foreign Application Priority Data
Oct. 18, 2013 (CN) 201310489969.5

(51) Int. Cl. H04L 12/713

(52) U.S. Cl. CPC H04L 45/586
USPC 370/392

(57) ABSTRACT

A network system capable of enhancing connection performance includes a first connection object, a second connection object, and a virtual lease line (VLL) network. The VLL network includes a number of router devices, a number of path control devices, and a management server. Each router device is coupled to one corresponding path control device, and each router device and the corresponding path control device are located in one corresponding area. The management server is coupled to all of the path control devices; the management and the path control devices establish a VLL constituted by a number of router devices according to areas in which the first connection object and the second connection object locates. The first connection object and the second connection object are coupled to each other and communicate with each other via the VLL established in the VLL network.

### CROSS-REFERENCE TO RELATED APPLICATIONS

This application claims priority to Chinese Patent Application No. 201310489969.5 filed on Oct. 18, 2013, the contents of which are incorporated by reference herein. This application is related to the following co-pending, commonly assigned patent applications, the disclosures of which are incorporated herein by reference in their entirety:

1. “TRANSMISSION PATH MANAGEMENT SYSTEM AND METHOD” by Zhou et al., whose Attorney Docket No is US53457.

2. “TRANSMISSION PATH CONTROL DEVICE” by Zhou et al., whose Attorney Docket No is US53454.

3. “TRANSMISSION PATH MANAGEMENT SYSTEM AND METHOD” by Zhou et al., whose Attorney Docket No is US53456.

4. “TRANSMISSION PATH CONTROL SYSTEM” by Zhou et al., whose Attorney Docket No is US53443.

5. “TRANSMISSION PATH MANAGEMENT DEVICE” by Zhou et al., whose Attorney Docket No is US53453.

6. “ON-DEMAND TRANSMISSION PATH PROVIDING SYSTEM AND METHOD” by Zhou et al., whose Attorney Docket No is US53455.

### FIELD

The present disclosure relates to network systems, and particularly to a network system capable of enhancing connection performance.

### BACKGROUND

Many businesses run computer centers located in different areas. Generally, the computer centers located in the different areas communicate with each other via randomly generated transmission paths on the Internet. However, the randomly generated transmission paths of the Internet usual are complex and may cause long delays.

### BRIEF DESCRIPTION OF THE DRAWINGS

Implementations of the present technology will now be described, by way of example only, with reference to the attached figures.

FIG. 1 is a block diagram of a first embodiment of a network system capable of enhancing connection performance.

FIG. 2 is a block diagram of a second embodiment of a network system capable of enhancing connection performance.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

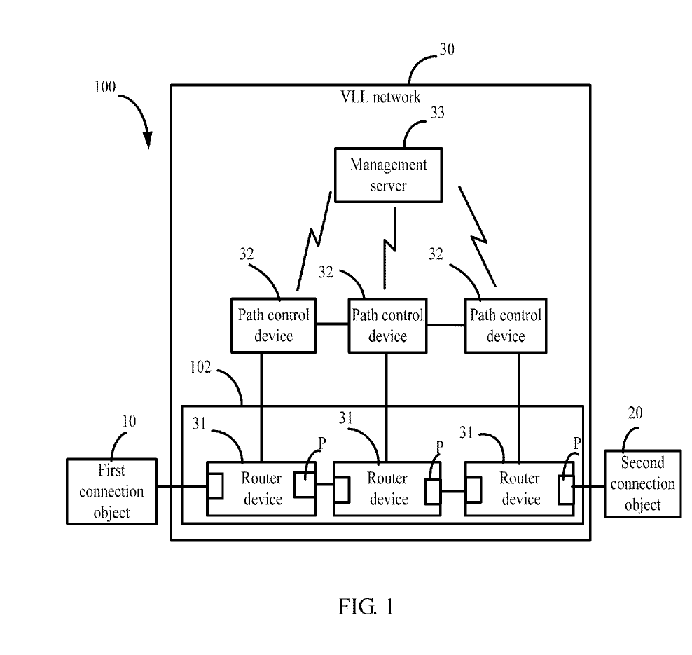

Referring to FIG. 1, a network system 100 capable of enhancing connection performance is illustrated. The network system 100 includes a first connection object 10, a second connection object 20, and a virtual lease line (VLL) network 30.

The first connection object 10 and the second connection object 20 are located in different areas, specially, located in different corresponding geographic area. For example, the first connection object 10 is located in New York, the second connection object 10 is located in Washington.

The VLL network 30 includes a number of router devices 31, a number of path control devices 32, and a management server 33. Each router device 31 is coupled to one corresponding path control devices 32, and the router device 31 and the corresponding path control devices 32 are located in one corresponding area. For example, one router device 31 and the corresponding path control devices 32 are located in Trenton, another router device 31 and the corresponding path control devices 32 are located in Philadelphia. The management server 33 is coupled to all of the path control device 32.

In the embodiment, the management server 33 and the path control devices 32 establish a VLL 102 constituted by corresponding number of router devices 31 according to the areas in which the first connection object 10 and the second connection object 20 locates. An amount of the corresponding number of router devices 31 constituting the VLL is less than or equal to an amount of the whole router devices 31 included in the VLL network 30. In the embodiment, each router device 31 further includes a number of ports P, and the VLL 102 is constituted by connecting the ports P of the router devices 31 one by one. The related technology of establishing the VLL 102 by the management server 33 and the path control devices 32 are disclosed in a related patent applications whose attorney docket No. are US53456 and US53457.

The first connection object 10 and the second connection object 20 are coupled to each other and communicate with each other via the VLL 102 established in the VLL network 30.

The first connection object 10 can be a computer, a mobile phone, and other terminal devices. The second connection object 20 can be Internet, a private network, a computer, or a mobile phone, for example. In another embodiment, the first connection object 10 and the second connection object 20 can be private networks located in different areas. Therefore, the first connection object 10 communicates with the second connection object 20 via the VLL 102 established in the VLL network 30, which enhances the access/transmission speed between them.

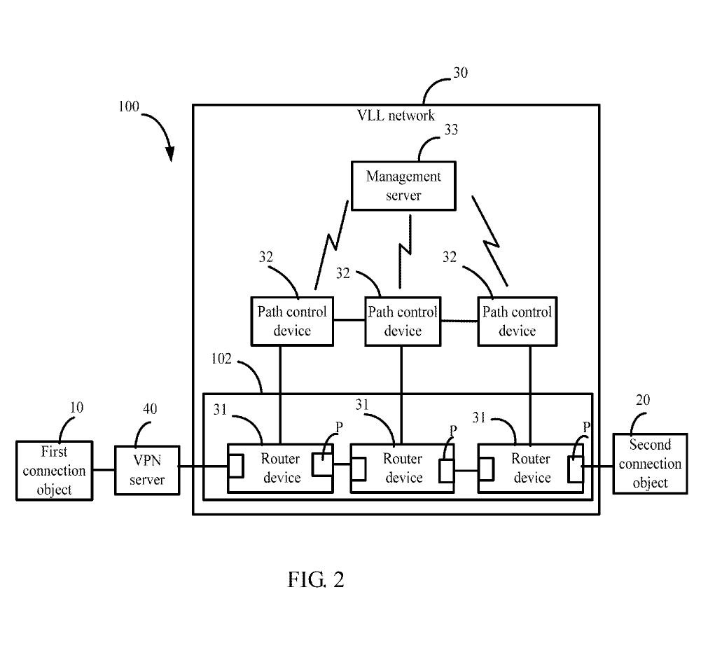

Referring to FIG. 2, in a second embodiment, the network system 100 further includes a virtual private network (VPN) server 40 located in the same area as that of the first connection object 10.

The first connection object 10 is coupled to the VPN server 40, and the VPN server 40 is coupled to the second connection object 20 via the VLL 102 established in the VLL network 30. Therefore, the first connection object 10 can couple to the second connection object 20 via the VLL 102 after coupling to the VPN server 40.

In the embodiment, because the first connection object 10 and the VPN server 40 are located in the same area, the connection performance between the first connection object 10 and the VPN server 40 is good. In addition, the VPN server 40 is coupled to the second connection object 20 via the VLL 102, and the connection performance between the VPN server 40 and the second connection object 20 is also good.

In the second embodiment, the first connection object 10 can be a computer, a mobile phone, and other terminal devices. The second connection object 20 can be Internet, a private network, a computer, or a mobile phone, for example. The first connection object 10 and the second connection object 20 also can be the private networks located in different areas.

In the first embodiment and the second embodiment, the management server 33 can be a single server or a server group. The path control device 32 can be a server or a personal computer. The router device 31 can be a router, a switch, or a gateway device.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A network system for enhancing connection performance comprising:
a first connection object;
a second connection object; and
a virtual lease line (VLL) network comprising:
a plurality of router devices;
a plurality of path control devices; and
a management server;
wherein, each of the plurality of router devices is coupled to one corresponding path control device, which is located in a same area as the router device; the management server is coupled to all of the plurality of path control devices; the management server and the plurality of path control devices establish a VLL constituted by a corresponding number of router devices according to areas in which the first connection object and the second connection object are located; the first connection object and the second connection object are coupled to each other and communicate with each other via the VLL established in the VLL network.

2. The network system according to claim 1, wherein each router device further comprises a plurality of ports, and the VLL is constituted by connecting the ports of the corresponding router devices one by one.

3. The network system according to claim 1, wherein the first connection object is a computer or a mobile phone, the second connection object is a Internet, a private network, a computer, or a mobile phone.

4. The network system according to claim 1, wherein the first connection object and the second connection object are private networks located in different areas.

5. The network system according to claim 1, further comprising a virtual private network (VPN) server located in the same area as that of the first connection object, the first connection object is coupled to the VPN server, and the VPN server is coupled to the second connection object via the VLL established in the VLL network.

6. The network system according to claim 5, wherein the first connection object is a computer or a mobile phone, the second connection object is a Internet, a private network, a computer, or a mobile phone.

7. The network system according to claim 1, wherein the management server is a single server or a server group.

8. The network system according to claim 1, wherein the path control device is a server or a personal computer.

9. The network system according to claim 1, wherein the router device is a router, a switch, or a gateway device.
